(19) United States
(12) Patent Application Publication
(10) Pub. No.: US 2011/0305260 A1
(43) Pub. Date: Dec. 15, 2011

(54) SYSTEM AND METHOD OF REFERENCE POSITION DETERMINATION

(75) Inventor: Ian McManus, Queensland (AU)

(73) Assignee: LEICA GEOSYSTEMS AG, Heerbrugg (CH)

(21) Appl. No.: 13/130,036

(22) PCT Filed: Dec. 2, 2009
(86) PCT No.: PCT/AU2009/001575

§ 371 Date: Aug. 31, 2011

(30) Foreign Application Priority Data
Dec. 5, 2008 (AU) 2008906307

(51) Int. Cl. H04B 1/00

(52) U.S. Cl. 375/130; 375/E01.001

(57) ABSTRACT

A method of reference position determination for a DGNSS base station. The base station comprises a memory, a logic controller and a GNSS receiver. Stored reference positions are stored in the memory as coordinate sets comprising components. The GNSS receiver determines a current estimate position of the base station as a coordinate set comprising components. The logic controller retrieves a stored reference position, converts the components of the stored reference position and the current estimate position to binary string format. The current estimate position is matched to the stored reference position by matching the binary string format components of the current estimate position with the binary string format components of the stored reference position. If the stored reference position is matched to the current estimate position, the base station is assigned the stored reference position as its reference position.

### FIELD OF THE INVENTION

The present invention relates to a system and method of reference position determination. In particular, the invention relates to a system and method of reference position determination for use with Differential Global Navigation Satellite Systems (DGNSS) such as Differential Global Positioning Systems (DGPS)

### BACKGROUND TO THE INVENTION

Many applications use methods and systems for position determination, e.g. a geodetic instrument, a vehicle or the like, which are based on global positioning systems, such as, for example, GPS, GLONASS or the European Galileo system. These Global Navigation Satellite Systems (GNSS) are based on the reception of satellite signals.

DGNSS are satellite positioning systems in which differential correction data is determined using a base station at a precisely known location (the reference position), which differential correction data is then transmitted to a roving GNSS receiver to improve the accuracy of the roving GNSS receiver. The base station has a GNSS receiver at the known location which compares the measurements of GNSS ranging signals received to those that would have been expected to have been received at the known location, thereby to generate the differential correction data based on the differences. The differential correction data is transmitted to the roving receiver by radio to be applied in real time to augment the GNSS signals received by the roving receiver and thereby provide more accurate positioning. In another example the base station transmits the precisely known position coordinates along with the actual measurements of the GNSS ranging signals received by the base station GNSS receiver. The roving GNSS receiver uses these measurements to form what are known in the art as single difference observations, which are used to calculate the position of the rover relative to the position of the base station. The relative position of the rover is mapped to an absolute position by adding change to a previously determined position of the rover. Although both examples of rover position determination are distinctly different, the resulting position solutions are mathematically equivalent.

The GNSS measurement errors which are corrected via differential techniques come about mostly due to atmospheric factors such as the amount of water vapour in the troposphere, or disturbances in the ionosphere caused by solar flares. These factors tend to become uncorrelated over long distances, but are highly correlated over short distances. A DGNSS thus provides for higher accuracy the closer the base station is to the roving receiver as the environmental factors for the two receivers are then more similar. If using radio to transmit the differential correction data, the base station and roving receiver must be close enough to each other so that the differential correction data can be transmitted between the base station and the roving receiver. One drawback to moving the base station is that it takes a long time for the base station to calculate an accurate new reference position. In agricultural uses the base station generally is moved between specific previous locations.

U.S. Pat. No. 7,400,294 and U.S. Pat. No. 6,140,959 both described DGNSS systems wherein the reference position for a base (reference) station is snapped to a previous stored position if the distance between the previous stored position and the current position is less than a set distance. These prior art patents are silent on how the distance between the two positions are determined or what methodology is used to match the positions.

### SUMMARY OF THE INVENTION

In one form, although it need not be the broadest form, the invention resides in a method of reference position determination for a DGNSS base station, the method including the steps of:

i) determining a current estimate position of the base station as a number of components of a coordinate set using a GNSS receiver;

ii) retrieving a stored reference position, from one or more stored reference positions which are stored in a memory of the base station, as a number of components of a coordinate set;

iii) converting two or more of the components of each of the coordinate sets of the stored reference position and the current estimate position to binary string format;

iv) matching the current estimate position to the stored reference position by matching two or more of the binary string format components of the current estimate position with two or more of the binary string format components of the stored reference position; and

v) assigning the base station a reference position being one of the stored reference positions if the stored reference position is matched to the current estimate position in the matching operation.

Preferably, all of the components of each of the coordinate sets of the stored reference position and the current estimate position are converted to binary string format and all of the binary string format components of the current estimate position are matched with corresponding binary string format components of the stored reference position.

Preferably, one or both of the coordinate sets of the stored reference position and the current estimate position are manipulated before matching the components of the coordinate sets.

Preferably, matching of the current estimate position with the stored reference position includes matching each component of the binary string format coordinate set of the current estimate position with the corresponding component of the binary string format coordinate set of the stored reference position.

Preferably, the method includes the step of manipulating one or both of the coordinate sets of the stored reference position and the current estimate position before matching the coordinate sets. Manipulations of the coordinate sets preferably include offsetting the components of the coordinate sets by a fixed value to ensure the coordinate sets comprise only positive components. Manipulation may also include scaling of the components after they have been offset.

Preferably, the method includes the step of calculating a new reference position and assigning the base station the new reference position if none of the stored reference positions match the current estimate position. The new reference position is preferably stored in the memory of the base station as a stored reference position.

Optionally, matching of the components of the coordinate sets include taking into account a lowest bit change in each of the components so that components having a difference only at the lowest bit are matched.

In another form of the invention, matching of the coordinate sets comprise:
concatenating the binary string format components of each of the current estimate position and the stored reference position;
performing a checksum algorithm on the concatenated binary string format components to determine a position checksum for each of the current estimate position and the stored reference position; and
comparing the position checksums to determine a match.

Preferably, each component, prior to concatenation, is rounded to the nearest multiple of a desired precision.

The invention extends to a system for reference position determination including a DGNSS base station which comprises:

a memory for storing one or more stored reference positions as coordinate sets comprising components;

a GNSS receiver for determining a current estimate position of the base station as a coordinate set comprising components; and

a logic controller which is operable to:
convert two or more of the components of each of the coordinate sets of the stored reference position and the current estimate position to binary string format;
match the current estimate position to the stored reference position by matching two or more of the binary string format components of the current estimate position with two or more of the binary string format components of the stored reference position; and
assign the base station a reference position being one of the stored reference positions if the stored reference position is matched to the current estimate position.

Preferably, the logic controller is configured to execute the method of reference position determination as defined and described hereinabove.

The invention also extends to a computer readable storage medium with an executable program stored thereon, wherein the program instructs a logic controller to perform the following steps:

converting two or more of the components of a coordinate set of a stored reference position stored in a memory to binary string format;

converting two or more of the components of a coordinate set of a current estimate position determined by a GNSS receiver to binary string format;

matching the current estimate position to the stored reference position by matching two or more of the binary string format components of the current estimate position with two or more of the binary string format components of the stored reference position; and

assigning the base station a reference position being one of the stored reference positions if the stored reference position is matched to the current estimate position.

Preferably, the program is configured to instruct the logic controller to perform the method of reference position determination as defined and described hereinabove.

Further features of the invention will become apparent from the following

### BRIEF DESCRIPTION OF THE DRAWINGS

By way of example only, preferred embodiments of the invention will be described more fully hereinafter with reference to the accompanying drawings, wherein:

FIG. 1 shows a schematic view of a DGPS for use in guidance of an agricultural vehicle, incorporating the system and method of the current invention;

FIG. 2 shows a schematic view of the agricultural vehicle utilizing the DGPS of FIG. 1;

FIG. 3 shows a schematic view of the portable base station of the DGPS of FIG. 1;

FIG. 4 shows a diagrammatic layout of one embodiment of the system of reference position determination in accordance with the invention;

FIG. 5 shows a basic diagrammatic flow diagram of one embodiment of the method of reference position determination in accordance with the invention; and

FIG. 6 shows a detailed diagrammatic data flow diagram of the flow and manipulation of data in accordance with the system and method of the current invention.

### DETAILED DESCRIPTION OF THE INVENTION

The invention will be described with reference to a DGPS for guidance of an agricultural vehicle, but is similarly applicable to any DGNSS system. The reference position determination system and method of the invention determines a reference position for a portable DGPS base station and assigns the reference position to the base station.

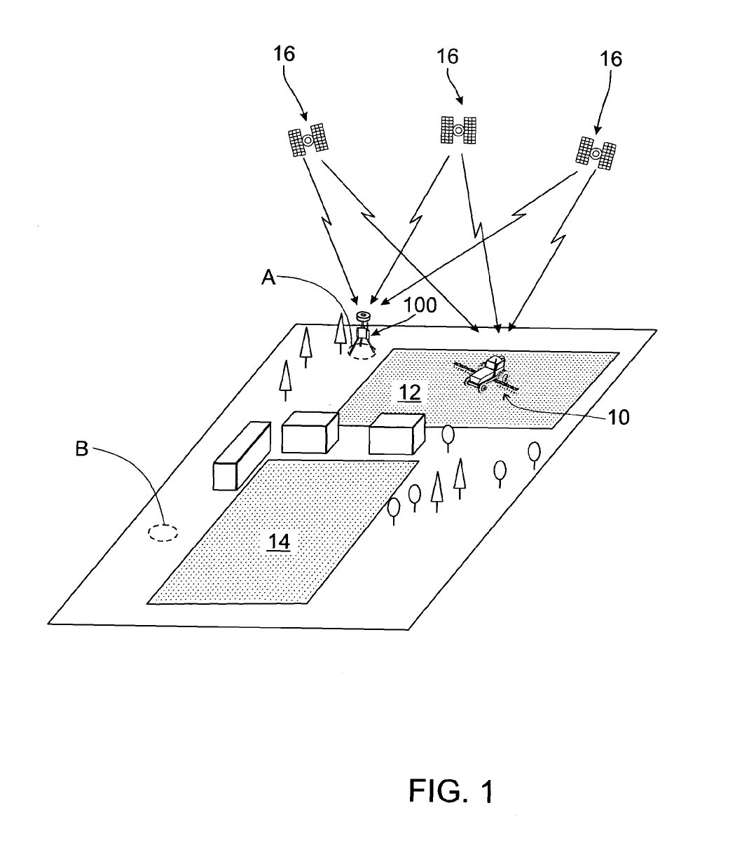

FIG. 1 shows one embodiment of an agricultural vehicle 10 utilizing a DGPS to navigate a tract of land 12. A portable base station 100 of the DGPS is located at a reference position “A” adjacent the tract of land 12. Another tract of land 14, which was previously worked by the vehicle 10, has a reference position “B” where the base station 100 was located when the tract of land 14 was worked.

The DGPS includes GPS satellites 16 which send GPS signals to both the base station 100 and a roving receiver of the vehicle 10.

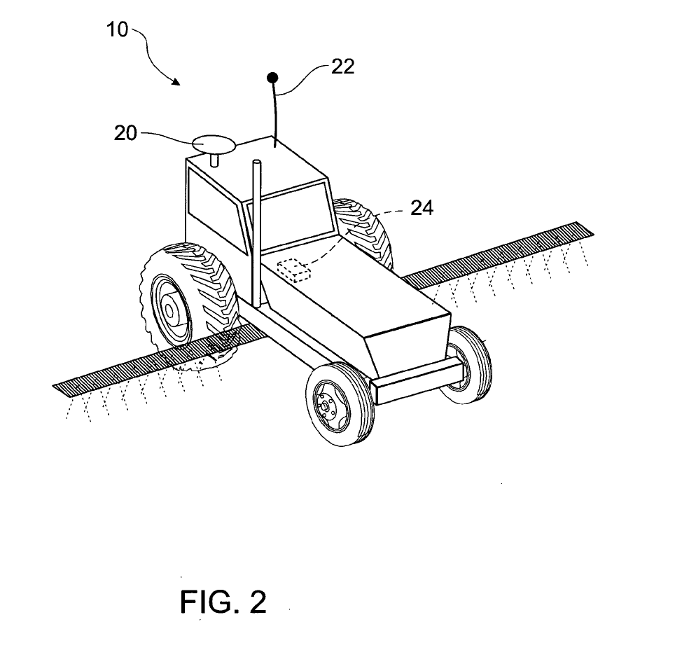

FIG. 2 shows the vehicle 10 including a GPS antenna 20 and a radio antenna 22. A roving GPS receiver 24 of the vehicle 10 receives GPS signals from the satellites 16. A radio receiver (not shown) receives radio signals from the base station 100, which carries differential correction data. The differential correction data augments the GPS signals so that the roving receiver 24 is able to calculate position more accurately.

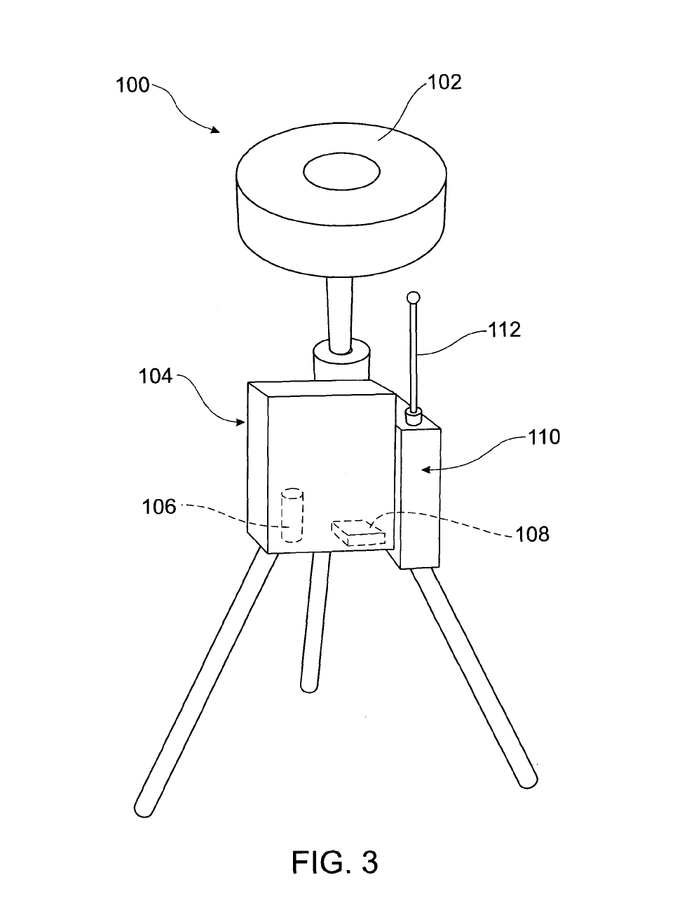

FIG. 3 shows one embodiment of the base station 100. The base station 100 includes a GPS antenna 102, a GPS receiver 104, a memory 106, a logic controller in the form of a central processor 108, and a radio transmitter 110 including a radio antenna 112. The memory 106 is a computer readable storage medium which has an executable program stored thereon to instruct the central processor to perform the steps of the method of reference position determination described herein below.

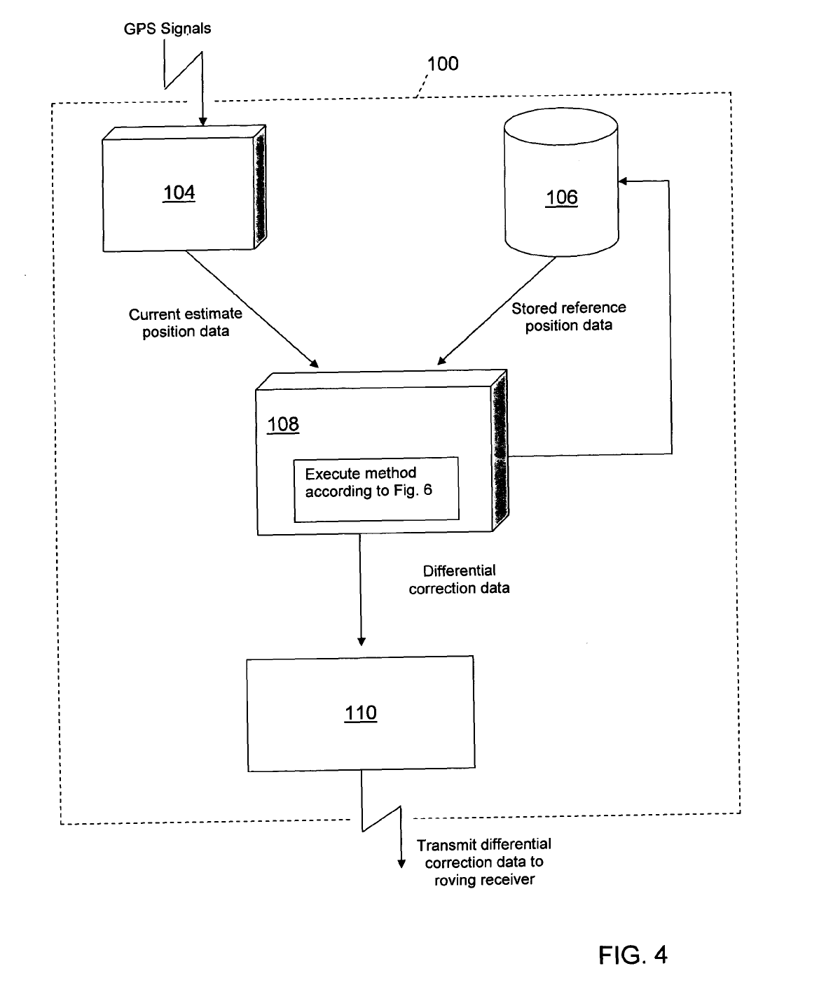

On startup the base station 100 is operable to determine its location very accurately as a reference position by reference position determination in accordance with the invention. This may be done either by snapping to a known stored reference position (position B for example) as will be described in more detail with reference to FIGS. 4 to 6 or by calculating a new reference position as is well known in the art.

After having calibrated itself to determine its reference position, the base station 100 is then operable to determine differential correction data and transmit, by radio, the correction data to the roving GPS receiver 24 of the vehicle 10.

FIG. 4 shows a diagrammatic layout of the base station 100 and the flow of data between the respective components of the base station 100. The base station receives GPS signals from the GPS satellites 16 and transmits differential correction data to the roving receiver 24.

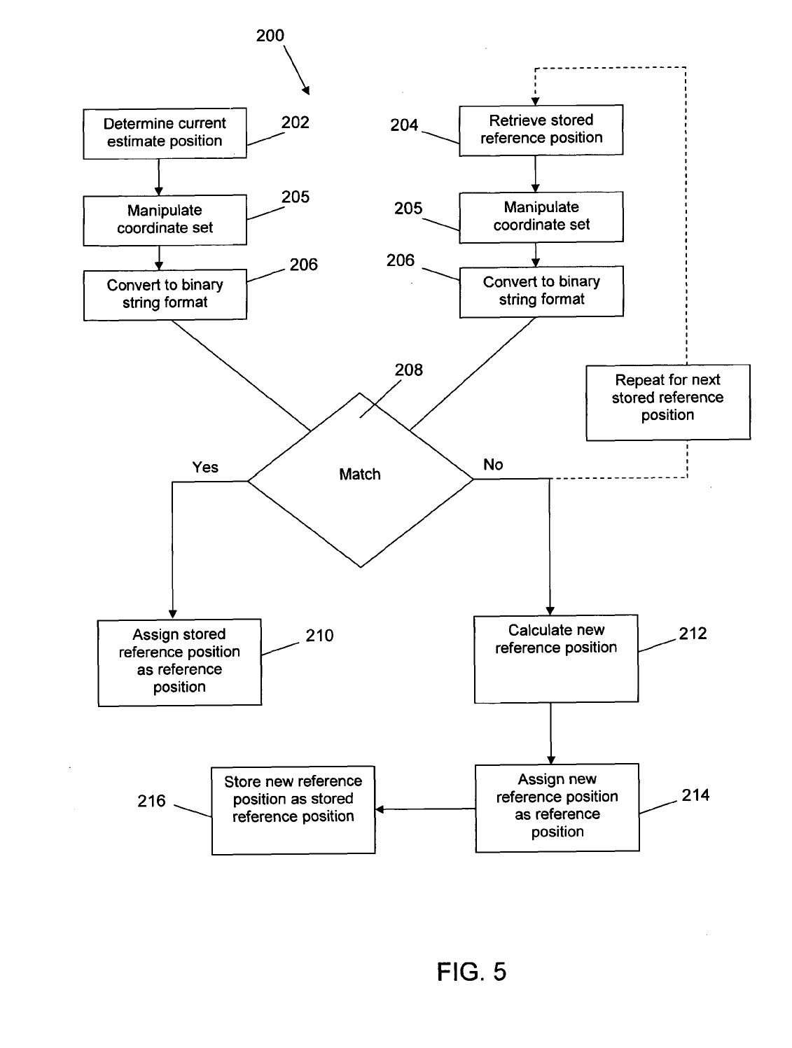

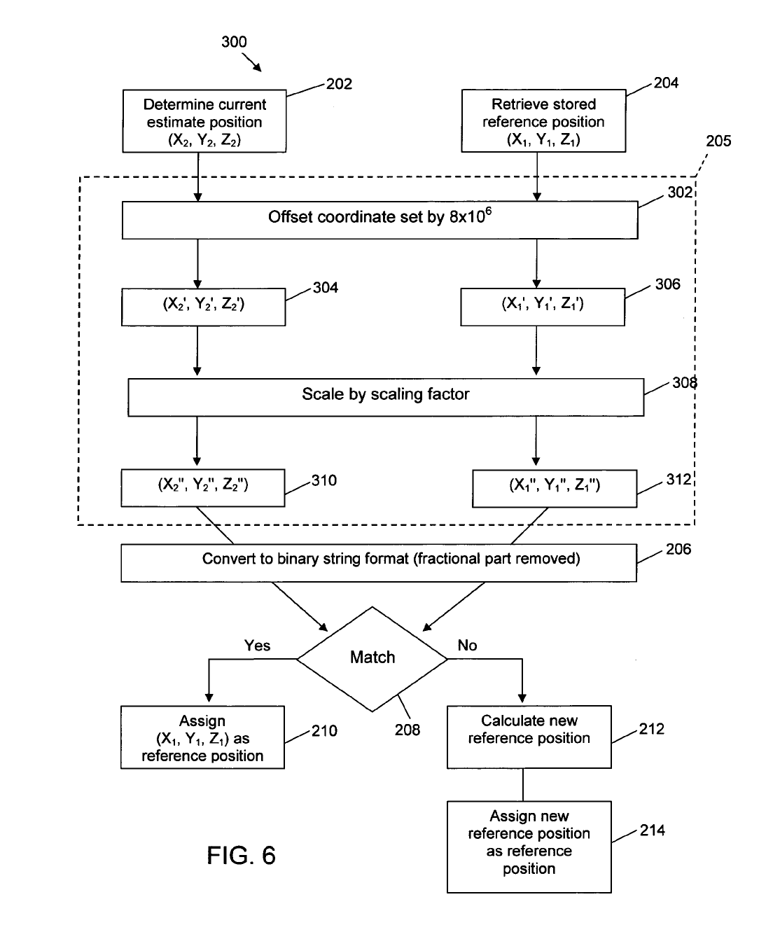

In FIG. 4, the GPS receiver 104 determines a current estimate position of the base station 100 and transmits current estimate position data to the central processor 108. Stored reference positions are stored in the memory 106 and are retrieved by the central processor 108 at startup to match to the current estimate position in order to assign a reference position to the base station 100. The method of matching the current estimate position with the stored reference position, as executed by the central processor 108, is generally described with reference to FIG. 5 and more specifically described with reference to FIG. 6. Once the base station 100 is assigned a reference position, the central processor 108 calculates differential correction data which is transmitted to the roving receiver 24 via the radio transmitter 110 of the base station 100.

FIG. 5 shows a flow diagram 200 of the basic method of reference position determination in accordance with one embodiment of the invention. In accordance with this method, the GPS receiver 104 determines the current estimate position of the base station 100 as indicated by reference numeral 202. The central processor 108 retrieves stored reference positions from the memory 106 as indicated by reference numeral 204.

The current estimate position and the stored reference positions are in the three component coordinate set (X,Y,Z) form of the Earth-Centered, Earth-Fixed (ECEF) system wherein the point (0,0,0) denotes the mass center of the earth. The coordinate set comprises X, Y and Z componets. The set of components may also be referred to as a tuple. Each component of the coordinate set is represented as a decimal number in its raw form. As is apparent, the ECEF system allows coordinate sets on the earth's surface terrain to have negative components. The positions may also be expressed in any other component coordinate system known in the art, including but not limited to other earth based coordinate systems, cylindrical and spherical coordinate systems and geodetic coordinate systems.

In the preferred embodiment as will be described in more detail with reference to FIG. 6, the coordinate sets are manipulated at step 205 by being offset and scaled. The components of each coordinate set of the stored reference position and the current estimate position are then converted to binary string format as indicated by reference numeral 206. The components are further manipulated when converting to binary string format in that the fractional parts of the components are removed.

The binary string format coordinate sets of the current estimate position are then matched with the binary string format coordinate sets of the stored reference position in a matching operation executed by the central processor 108. The matching operation is indicated by reference numeral 208 and is described in more detail with reference to FIG. 6. The matching operation is repeated for each of the stored reference positions stored in the memory 106 until a positive match is found.

If the current estimate position matches any of the stored reference positions the central processor 208 assigns that stored reference position as the reference position of the base station 100, as indicated by reference numeral 210. If no match is found the central processor 208 calculates a new reference position from the current estimate position data received from the GPS receiver 104 over time, indicated by reference numeral 212. The central processor 108 then assigns the new reference position as the reference position of the base station 100, as indicated by reference numeral 214. The new reference position is also stored as a stored reference position in the memory 106, as indicated by reference numeral 216.

FIG. 6 shows a more specific flow diagram 300 of how the base station 100 self calibrates. In FIG. 6, steps in the method of reference position determination which are the same as the steps described in FIG. 5 are indicated by the same reference numerals. The step of manipulation 205 of the coordinate sets is broken down in more detail in FIG. 6.

Upon startup the GPS receiver 104 of the base station 100 receives GPS signals from the satellites 16 to determine its current estimate position represented as the coordinate set (X₂, Y₂, Z₂) as indicated by reference numeral 202.

One of a number of stored reference positions (position B from FIG. 1 for example) is represented by coordinate set (X₁, Y₁, Z₁) and is stored in the memory 106 of the base station 100. The stored reference position coordinate set (X₁, Y₁, Z₁) is retrieved from the memory 106 as indicated by reference numeral 204.

In a next step the components of both the current estimate position coordinate set (X₂, Y₂, Z₂) and the stored reference position coordinate set (X₁, Y₁, Z₁) are ensured to be positive by applying an offset of positive 8×10⁶ to each of the components of the coordinate sets. The step of offsetting the components of the coordinate sets is indicated by reference numeral 302.

The offset coordinate sets are represented as (X₂′, Y₂′, Z₂′) and (X₁′, Y₁′, Z₁′), respectively, where:

X₁′=X₁+8×10⁶

Y₁′=Y₁+8×10⁶

Z₁′=Z₁+8×10⁶

X₂′=X₂+8×10⁶

Y₂′=Y₂+8×10⁶

Z₂′=Z₂+8×10⁶

The offset current estimate position coordinate set (X₂′, Y₂′, Z₂′) and the offset stored reference position coordinate set (X₁′, Y₁′, Z₁′) are indicated in the flow diagram 300 by reference numerals 304 and 306, respectively.

In yet a further step the components of each of the offset coordinate sets (X₂′, Y₂′, Z₂′) and (X₁′, Y₁′, Z₁′) are scaled to a predetermined precision by a scaling factor by dividing the offset coordinate sets by the scaling factor. The scaling factor is chosen depending on how precise the matching between the offset coordinate sets must be. A larger scaling factor would result in the offset coordinate sets being matched more easily than if the scaling factor was smaller. The scaled coordinate sets are represented as (X₂″, Y₂″, Z₂″) and (X₁″, Y₁″, Z₁″), respectively, where:

X₁″=(X₁+8×10⁶)/scaling factor

Y₁″=(Y₁+8×10⁶)/scaling factor

Z₁″=(Z₁+8×10⁶)/scaling factor

X₂″=(X₂+8×10⁶)/scaling factor

Y₂″=(Y₂+8×10⁶)/scaling factor

Z₂″=(Z₂+8×10⁶)/scaling factor

The step of scaling the components of the coordinate sets is indicated by reference numeral 308. The scaled current estimate position coordinate set (X₂″, Y₂″, Z₂″) and the scaled stored reference position coordinate set (X₁″, Y₁″, Z₁″) are indicated by reference numerals 310 and 312, respectively.

A matching operation is then performed between the scaled current estimate position coordinate set (X₂″, Y₂″, Z₂″) and the scaled stored reference position coordinate set (X₁″, Y₁″, Z₁″) to determine if the current estimate position matches the stored reference position.

For the matching operation, the components of the coordinate sets are first converted to binary string format (32 bit unsigned integers) with fractional part removed. The conversion to binary string format is indicated by reference numeral 206. The following matching algorithm is then performed:

```
If ((X₁″ XOR X₂″) OR (Y₁″ XOR Y₂″) OR (Z₁″ XOR Z₂″)) is 0 then
            Positions match
Else
            Positions do not match
```

The applicant has found that is beneficial to account for single bit changes at the lowest bit. The preferred matching algorithm is thus further developed to take into account a lowest bit change in each of the components so that components having only a difference at the lowest bit are matched. Such further developed matching algorithm to be performed is given below:

Ensure that X₁″ is less than X₂″, Y₁″ is less than Y₂″ and Z₁″ is less than Z₂″.
If X₁″>X₂″ then Swap(X₁″, X₂″)
If Y₁″>Y₂″ then Swap(Y₁″, Y₂″)
If Z₁″>Z₂″ then Swap(Z₁″, Z₂″)

Each pair of components are XOR'd to identify any differences and the results are then OR'd. This is performed for each possible lowest bit change:

```
        If ((X₁″ XOR X₂″) OR (Y₁″ XOR Y₂″) OR (Z₁″ XOR Z₂″))
        is 0 then
            Positions match
        Else If ((X₁″ XOR X₂″) OR (Y₁″ XOR Y₂″) OR (Z₁″ +
1 XOR Z₂″)) is 0 then
            Positions match
        Else If ((X₁″ XOR X₂″) OR (Y₁″ + 1 XOR Y₂″) OR (Z₁″
XOR Z₂″)) is 0 then
            Positions match
        Else If ((X₁″ XOR X₂″) OR (Y₁″ + 1 XOR Y₂″) OR (Z₁″ +
1 XOR Z₂″)) is 0 then
            Positions match
        Else If ((X₁″ + 1 XOR X₂″) OR (Y₁″ XOR Y₂″) OR (Z₁″
XOR Z₂″)) is 0 then
            Positions match
        Else If ((X₁″ + 1 XOR X₂″) OR (Y₁″ XOR Y₂″) OR (Z₁″ +
1 XOR Z₂″)) is 0 then
            Positions match
        Else If ((X₁″ + 1 XOR X₂″) OR (Y₁″ + 1 XOR Y₂″) OR (Z₁″
XOR Z₂″)) is 0 then
            Positions match
        Else If ((X₁″ + 1 XOR X₂″) OR (Y₁″ + 1 XOR Y₂″) OR (Z₁″ +
1 XOR Z₂″)) is 0 then
            Positions match
        Else
            Positions do not match
```

The matching operation is indicated by reference numeral 208 in the flow diagrams 200 and 300.

If the current estimate position coordinate set (X₂″, Y₂″, Z₂″) and the stored reference position coordinate set (X₁″, Y₁″, Z₁″) matches as per the matching algorithm above, the base station 100 is assigned the stored reference position coordinate set as a reference position. This is also known as snapping to the stored reference position and is indicated by reference numeral 210 in the flow diagrams 200 and 300.

If the current estimate position coordinate set (X₂″, Y₂″, Z₂″) does not match any one of the stored reference position coordinate sets (X₁″, Y₁″, Z₁″), the base station 100 calculates a new reference position as indicated by reference numeral 212. The new reference position is calculated by taking a number of current estimate positions over a predetermined time period and calculating the reference over the time period. This has the drawback that the base station is not immediately available for calculating and transmitting differential correction data while resolving the new reference position.

It must be appreciated that there would generally be a number of stored reference position coordinate sets in the memory 106 of the base station 100 on which the above matching operation is performed to determine if there is a matching reference position coordinate set.

To further exemplify the invention, one example of the matching operation being performed between a hypothetical current estimate position and a hypothetical stored reference position is given below. In the example:

the stored reference position is: (1002712, −4598060, 4290846); and

the current estimate position is: (993236, −4590107, 4301406).

The components are offset by 8×10⁶ so that the:

offset stored reference position is (9002712, 3401940, 12290846); and

the offset current estimate position is: (8993236, 3409893, 12301406).

Assuming the desired accuracy is 0.5 m the components are then scaled by a scaling factor of 0.5 so that the:

scaled stored reference position is (18005424, 6803880, 24581692); and

the scaled current estimate position is: (17986472, 6819786, 24602812).

The components of the coordinate sets are then converted to binary string format with the fractional parts removed, so that the:

binary stored reference position is:
(00000001-00010010-10111101-10110000, 00000000-01100111-11010001-10101000, 00000001-01110111-00010110-00111100); and

the binary current estimate position is :
(00000001-00010010-01110011-10101000, 00000000-01101000-00001111-11001010, 00000001-01110111-01101000-10111100).
   The coordinate sets are then matched as per the matching algorithm. For the example described the current estimate position does not match the stored reference position and hence a next stored reference position will be tested.

An alternative, but currently not preferred, embodiment of a matching algorithm is for each pair of components to be XOR'd to identify any differences and the results are then OR'd. This result is then AND'd with a mask M. This

```
    If ((X1″ XOR X2″) OR (Y1″ XOR Y2″) OR (Z1″ XOR Z2″))
AND M is 0 then
                        Positions match
        Else
                        Positions do not match
```

This test will however fail if there is a difference in one of the bits within the mask which causes a corresponding change in the upper bits. For example: 16 correspond to 0001 0000 in binary and 15 corresponds to 0000 1111. If the mask M is 15 (ie. If two the two positions are less than 15 m apart then match) then the test would fail for this case. To handle this it is necessary to account for any bit changes that may occur in the masked out components. For a large mask this would result in a large number of calculations.

It is not necessary for all of the components X,Y and Z to be matched, and the Applicant envisages that in some applications only two of the components will be matched. Alternatively, the different components may be scaled differently so that the ease at which different components are matched is different. In certain coordinate systems this will allow there to be a greater allowance for height matching than longitudinal or latitudinal matching.

In another embodiment of the invention, a checksum algorithm is used to perform a matching operation between the stored reference positions and the current estimate position. The components of the coordinate sets are first converted to 32 bit unsigned integers (fractional part removed). An offset of 8×10⁶ is then added to each component to guarantee that all components are positive. Each component is rounded to the nearest multiple of a desired precision. Next, the components for each coordinate set is converted to a binary string and concatenated to form a single binary string. During this conversion, the strings (corresponding to a component) shall be truncated to achieve the required accuracy. For example, removing the 3 least significant bits will result in a worst case accuracy of ˜12.1 metres. A checksum is then performed on the concatenated binary string, which results in a current estimate position checksum.

The base station 100 shall, after determining its current estimate position checksum, determine corresponding stored reference position checksums. If a matching checksum is found in the list of stored reference that stored reference position is used as the reference position for the base station 100.

Throughout the specification the aim has been to describe the present invention without limiting the invention to any one embodiment or specific collection of features. Persons skilled in the relevant art may realize variations from the specific embodiments that will nonetheless fall within the scope of the present invention. For example, the stored reference positions may be offset and stored as offset coordinate sets, offset and scaled coordinate sets, or offset and scaled coordinate sets which have been converted to 32 bit unsigned integers. The manipulation steps of offset and scaling may also occur after the components have been converted to binary string format.

1. A method of reference position determination for a DGNSS base station, the method including the steps of:
determining a current estimate position of the base station as a number of components of a coordinate set using a GNSS receiver;
retrieving a stored reference position, from one or more stored reference positions which are stored in a memory of the base station, as a number of components of a coordinate set;
converting two or more of the components of each of the coordinate sets of the stored reference position and the current estimate position to binary string format;
matching the current estimate position to the stored reference position by matching two or more of the binary string format components of the current estimate position with two or more of the binary string format components of the stored reference position; and
assigning the base station a reference position being one of the stored reference positions if the stored reference position is matched to the current estimate position in the matching operation.

2. The method of claim 1, wherein all of the components of each of the coordinate sets of the stored reference position and the current estimate position is converted to binary string format.

3. The method of claim 1, wherein all of the binary string format components of the current estimate position are matched with the binary string format components of the stored reference position.

4. The method of claim 1, wherein matching of the current estimate position with the stored reference position includes matching each component of the binary string format coordinate set of the current estimate position with a corresponding component of the binary string format coordinate set of the stored reference position.

5. The method of claim 1, wherein the method includes the step of manipulating one or both of the coordinate sets of the stored reference position and the current estimate position before matching the components of the coordinate sets.

6. The method of claim 1, wherein the method includes the step of calculating a new reference position and assigning the base station the new reference position if none of the stored reference positions match the current estimate position.

7. The method of claim 6, wherein the method includes the step of storing the new reference position in the memory of the base station as a stored reference position.

8. The method of claim 5, wherein manipulation of the coordinate sets include offsetting the components of the coordinate sets by a fixed value to ensure the coordinate sets comprise only positive components.

9. The method of claim 5, wherein manipulation of the coordinate sets include scaling of the components of the coordinate sets.

10. The method of claim 8, wherein the components of the coordinate sets are scaled after the components have been offset.

11. The method of claim 9, wherein scaling of the coordinate sets comprise dividing each of the components by a scaling factor.

12. The method of claim 1, wherein matching of the components of the coordinate sets include taking into account a lowest bit change in each of the components so that components having a difference only at the lowest bit are matched.

13. The method of claim 1, wherein matching of the current estimate position to the stored reference position comprises:
concatenating the binary string format components of each of the current estimate position and the stored reference position;
performing a checksum algorithm on the concatenated binary string format components to determine a position checksum for each of the current estimate position and the stored reference position; and
comparing the position checksums to determine a match.

14. A system for reference position determination including a DGNSS base station which comprises:
a memory for storing one or more stored reference positions as coordinate sets comprising components;
a GNSS receiver for determining a current estimate position of the base station as a coordinate set comprising components; and
a logic controller which is operable to:
convert two or more of the components of each of the coordinate sets of the stored reference position and the current estimate position to binary string format;
match the current estimate position to the stored reference position by matching two or more of the binary string format components of the current estimate position with two or more of the binary string format components of the stored reference position; and
assign the base station a reference position being one of the stored reference positions if the stored reference position is matched to the current estimate position.

15. A computer readable storage medium with an executable program stored thereon, wherein the program instructs a logic controller to perform the following steps:
converting two or more of the components of a coordinate set of a stored reference position stored in a memory to binary string format;
converting two or more of the components of a coordinate set of a current estimate position determined by a GNSS receiver to binary string format;
matching the current estimate position to the stored reference position by matching two or more of the binary string format components of the current estimate position with two or more of the binary string format components of the stored reference position; and
assigning the base station a reference position being one of the stored reference positions if the stored reference position is matched to the current estimate position.

16. The method of claim 10, wherein scaling of the coordinate sets comprise dividing each of the components by a scaling factor.
